(19) United States
(12) Patent Application Publication
(10) Pub. No.: US 2021/0179369 A1
(43) Pub. Date: Jun. 17, 2021

(54) SUCTION DEVICE FOR EMPTYING A CONTAINER

(71) Applicant: EJOT GmbH & Co. KG, Bad Berleburg (DE)

(72) Inventors: Martin Schmidt, Bad Laasphe (DE); Kim Bastian Kroh, Bad Berleburg (DE); Maik-Sebastian Saft, Erndtebrück (DE)

(21) Appl. No.: 15/734,117

(22) PCT Filed: Jun. 3, 2019
(86) PCT No.: PCT/EP2019/064317

§ 371 Date: Dec. 1, 2020

(30) Foreign Application Priority Data
Jun. 13, 2018 (DE) 10 2018 209 465.9

(51) Int. Cl. B65G 65/38; B65B 69/00; B65G 53/24; B65G 53/52

(52) U.S. Cl. CPC B65G 65/38; B65B 69/0075; B65G 2201/042; B65G 53/528; B65G 53/24

(57) ABSTRACT

The invention relates to a suction device for emptying a container, in particular for emptying a container filled with granular material. The suction device has a plurality of intakes, at least one distributor, the at least one distributor being adapted to connect the plurality of intakes to a central suction line, and a means for holding, which holds at least one first intake of the plurality of intakes at a distance from at least one second intake of the plurality of intakes. The invention further relates to a method and to a system for emptying a container, in particular for emptying a container filled with granular material.

The present invention generally relates to a suction device for emptying a container, in particular for emptying a container filled with granular material.

In many technical fields, raw materials are processed in technical plants. These raw to materials may be present in the form of loose material, such as bulk material, granulate or powder, all of which can be considered granulated. Common raw materials are for example plastic particles or glass-fiber-like particles. The raw materials are typically stored in large containers, so that they can be easily used in the technical plants.

When processing raw materials, these are then taken from the containers and fed to the system or the processing machine.

In most cases, the containers are emptied by suction of the raw material from the container. During suction, a material is sucked out of the container via a suction line. The suction line has two openings at opposite ends. The first opening of the two openings is placed inside the container, typically close to the raw material to be sucked in or directly into the raw material to be sucked. Negative pressure is applied at the second opening. The negative pressure will result in a suction, i.e. a suction force caused by the negative pressure. Via the suction line, the suction force is directed to the second opening, so that a suction is created at the second opening. This suction results in a suction force directed towards the first opening and into the suction line. The suction force then acts upon the material to be sucked. If the suction force is large enough, the material is sucked into the first opening and finally through the first opening into the suction line. In this regard, it is important, on the one hand, that the raw material to be sucked, i.e. the particle size has smaller dimensions than the opening so that the raw material can be sucked through the opening. On the other hand, the negative pressure must be so strong enough so that the suction force is large enough to overcome the forces that hold the raw material in the container. In most cases, these forces only consist approximately of the weight force of the individual particles of the raw material. In special cases, however, forces may also occur that keep the raw material together. For example, adhesion forces may be encountered between the particles of the raw material. Moreover, it is also possible that forces occur which hold the raw material in the container. For example, adhesion forces which may be encountered between the particles of the raw material and the container or a part of the container.

Examples of containers that are suitable for containing granulated material are so-called big bags or so-called octabins. A big bag is a term for a large bag-like container. An octabin is a container consisting of a fixed octagonal perimeter wall, such as cardboard, a bottom and an optional lid. Depending on the material used, an octabin may have a flexible inner container in which the granulate-like material can be filled. For example, it may be advantageously to use an inner container for very fine-grained particles so that the fine-grained particles do not sit in the edges of the cardboard of which the octabin can be composed of. Equally, using an inner container can protect the granular material from environmental influences. If, for example, hygroscopic granulated material is transported, i.e. material which binds moisture from the environment, the material in the inner container can be protected against a damp environment. It is also possible to extend the recyclability of an octabine by using an inner container, since the octabin itself does not come into contact with the granulated material and thus is not contaminated. Moreover, the flexible inner container prevents particles from entering the environment unintentionally, for example during transport.

The flexible inner container, often referred to as an inlet, can be designed in the form of a bag made of a foil. This bag can be placed loosely in the octabin or can be firmly connected to the octabin. If the octabin has a flexible inner container, the material is filled into the flexible inner container. Otherwise, the material is filled directly into the octabin.

Solutions known from the art for emptying corresponding containers use a central suction line with an intake opening arranged thereon. The intake opening is placed in the container and negative pressure is applied to the suction line so that a suction force is created which pulls the granulated material through the intake opening into the suction line. Since the intake opening usually does not cover the entire base surface of the container, the intake opening is generally not suitable for extracting the entire granulated material from the container. With one intake opening, the granular material can thus only be sucked in locally at the position of the intake opening.

Furthermore, the extraction becomes more and more ineffective the less granular material is located in the container. If there is only little granulated material in the container left, the intake opening is mainly surrounded by the ambient air, so that the intake opening mainly draws in air and only a few particles. Often the solutions known in the art are therefore adapted to move the intake opening in the container relatively to the container in order to also extract the granulate at the points that cannot be reached by the intake opening in its initial position, i.e. without the relative movement. It is both possible to move the container relative to the intake opening or to move the intake opening relative to the container. Combinations of these movements are also conceivable. Furthermore, this relative movements make it possible to move the intake opening to a position in which granulated material is still to be sucked. This can be done, for example, by moving the intake opening in the container towards the granulate-like material to be sucked in or by the container being tilted or moved against a rigidly fixed intake opening. Combinations of the relative movements of the intake opening and the container are also conceivable. If the container has a flexible inner container, a relative movement between the flexible inner container and the intake opening is also possible.

However, the solutions known from the art have the disadvantage that due to the necessity of a relative movement between the intake opening and the container, they usually use a complicated construction of holding and movement devices, which facilitate such a relative movement. Because of this, these devices are expensive in production and also complicated in operation and maintenance.

Therefore, the object of the present invention is to overcome the aforementioned disadvantages and to simplify the construction and make the use of a suction device more efficient, to make the suction device more durable and to simplify the storage of the suction device if not in use.

This problem is solved by a suction device according to the independent claim of the present invention. Preferred and advantageous embodiments can be found in the dependent claims.

The suction device according to the invention for emptying a container, in particular for emptying a container filled with granulated material, comprises a plurality of intakes. For example, an intake may be a part of a connection, such as a part of a pipe or a tube. In this regard this part may comprise a higher stiffness than the rest of the pipe or tube. This stiffness can help the intake to enter the material. However, an intake can also just be an opening. Each intake has at least one opening, in particular a suction opening, through which granulate-like material can be extracted when a suction is applied to it. A plurality of intakes is defined to mean two or more intakes.

Due to the plurality of intakes, the suction device according to the invention enables, for example, the simultaneous suction of granulate-like material at several positions within the container, without a relative movement or only a few relative movements between the suction device and the container being necessary. Due to the plurality of intakes, these can be positioned at several positions spaced apart within the container so that at each of these positions granulated material can be sucked or sucked in via at least one intake.

In addition to the plurality of intakes, the suction device comprises at least one distributor. This at least one distributor is adapted to connect the plurality of intakes to a central suction line. A central suction line is a suction line via which a vacuum can be connected to the suction device or the suction device can be subjected to a negative pressure. This allows, for example, the negative pressure to be applied which is necessary to generate a suction force at at least one of the intakes of the plurality of intakes. In a preferred embodiment, suction force is provided at each of the intakes of the plurality of intakes, in order to suck in granulated material through the intakes. For example, a suction force can be produced simultaneously at all intakes, or the suction force can be produced alternately at different intakes.

Hence, the at least one distributor is therefore adapted to distribute the suction power provided by a suction unit.

The central suction line itself does not need to be part of the described device. It may be a central suction line of an external apparatus, wherein the apparatus is capable of generating negative pressure at the central suction line. For example, the central suction line can be the suction line of an industrial suction appliances. The explicit operation of such a suction appliance is not to be described in more detail.

The suction device according to the invention furthermore comprises at least one means for holding, which holds at least one first intake of the plurality of intakes in a distance to at least one second intake of the plurality of intakes.

The at least one means for holding allows the positioning of the intakes relative to one another and relative to the container to be emptied. For example, every intake can be held by at least one means for holding. This allows the intakes to be positioned individually. This means that every single position of the plurality of intakes can be adjusted individually via their means for holding. This adjustment can be done manually or automatically. This allows for a high number of degrees of freedom when choosing the position of the intakes.

The at least one means for holding can also be adapted to support two or more intakes, possibly even the entire plurality of intakes, in order to provide increased stability of the suction device. However, the means for holding can still be adjusted to position the individual intakes.

In order that suction device according to the invention can be used, the suction device according to the invention has to be connected to a central suction line and placed in a container. In contrast to the suction devices known in the art, the suction device according to the invention does not require any complicated additional devices that manage a relative movement between the container and the intake opening. By this alone, the suction device according to the invention is designed in a more compact and simple manner. Due to the simpler construction, the suction device according to the invention is also more efficient and cost-effective.

In a preferred embodiment, the number and/or the distribution of the intakes may be adapted to the container to be emptied. For example, the number and/or distribution of the intakes may be adjusted to the shape, size or cross-section of the container to be emptied. For example, a design that allows a versatile application in the range of octabins can have five intakes. One of the first four intakes can be located in each of the four corners of a rectangle, the surface of which is essentially parallel to a base surface of the container, and the remaining one of the total five intakes can be inside the surface formed by the rectangle described. This remaining one of the five intakes can be referred to as a second intake, for example. In one example, the rectangle, which is formed by the first four intakes in the respective corners of the rectangle, can be any arbitrary rectangle. Two of the first four intakes can have a certain distance to an adjacent other one of the first four intakes, with an adjacent intake being an intake located in an adjacent corner of the rectangle. In this case, the specific distance may correspond to the length of the side of the rectangle that connects the corner of the first intake to the corner of the adjacent intake. In an example, the rectangle created can be a square. In the case of a square, all four first intakes have the same distance from their adjacent intakes.

In a further preferred embodiment, the first four intakes can each have a certain distance from the second intake. This specific distance to the second intake can be the same or different for each of the first four intakes. If the first four intakes form a square, for example, and if the second intake is located in the center of the surface of the square, for example at a position where the diagonals of the surface of the square intersect, the distances between the first four intakes and the second intake can be the same.

An arrangement of a plurality of first intakes, for example of four first intakes in the form of a rectangle, and a second intake, for example in the surface of the rectangle, allows the container to be emptied simultaneously at several positions of the container, which are distributed relative to the base surface of the container. This allows more effective emptying even without relative movement of the container and the intakes, as several positions are available where material can be extracted from the container. The person skilled in the art is aware that any desired number of intakes can be used and that this number can be adjusted to the geometry, i.e., for example, the cross-section of the container.

If the suction device according to the invention has a configuration of the plurality of intakes that allow the extraction of granular material at several distributed positions of a container, it can be the case that granular material remains in the spaces between the intakes, i.e. in the positions where no intake is located. For example, small hills can form of granulated material. However, due to the gravitational force that affects the particles of the granulated material, the particles will slip at least partially to the positions of the intakes and thus be sucked. The number of intakes can therefore be adjusted to favor an optimal subsequent sliding of the granulated material, so that no or very few relative movements of the suction device and the container are necessary.

In a further preferred embodiment, the intakes of the suction device can comprise at least one spacer, which is located at the respective intake and partially extends over the at least one suction opening of the intake, which is used for sucking in the granular material. If an intake of the plurality of intakes has more than one suction opening, each of these suction openings can have a spacer. A spacer can be designed in an arched manner, rectangular or trapezoid manner, for example.

The spacer does not close the suction opening of the intake and can ensure that the corresponding suction opening of the intake does not come into contact with the inside of the container. This prevents suction of the intake on the inside of the container. This is particularly advantageous where the container to be emptied has a flexible inner container, since these flexible inner containers are usually placed in the container and are thus easily movable. Moreover, such a spacer also prevents larger particles of the granulate-like material to be sucked in and jam the suction line, for example, if the granulate-like material is contaminated or if several particles of the granular material have accumulated and form a contiguous chunk or block.

In another preferred embodiment, the distributor of the suction device comprises at least one suction manifold. This suction manifold has a first end portion and a second end portion. The first end portion of the suction manifold comprises a first opening, which is adapted to be connected to the central suction line, and the second end portion comprises a plurality of second openings, with each second opening being adapted to be connected to at least one intake. In this case, a plurality of second openings means two or more second openings. The suction manifold therefore allows the suction power to be distributed from the first opening to the plurality of intakes.

For example, the suction manifold can have a connection that can be connected to a suction line so that the suction manifold can be adapted to the central suction line. This connection can be used, for example, to adapt the suction manifold to a suction line from a variety of different central suction lines. This improves the application possibilities of the suction device, as the suction device is independent of the central suction line used. For example, the distributor of the suction device can be designed in such a way that it can be connected with a variety of commercially available suction apparatuses, so that when purchasing the suction device in accordance with the invention, only the suction device needs to be purchased and the suction device can subsequently be operated with an already existing suction apparatus. For example, the connection can be a quick-change connection. The connection can also be adjusted to several different suction lines. For example, the connection can also have an adapter so that several different suction lines can be connected.

The suction manifold can be hollow or consist of lines designed such that the first opening of the suction manifold branches and passes into the second openings. Such branching can be done in multi-stages. For example, when the first opening branches into a number of intermediate lines, which finally branch into the second openings. Several stages of intermediate lines are also possible. However, it is also possible that the branching occurs directly from the first opening to the plurality of second openings. The type and shape of the branch can be designed taking into account flow dynamics.

For example, the lines may be at least partially angled to enable a branch of the first opening into the second openings. The winding of the lines can ensure that the lines are in a spatial relationship with the first opening, which is advantageously to the flow dynamic, and that suction power loss does not occur or that the suction power losses are marginal. In one example, the lines each have an angle of 45° to the normal of the first opening.

In another preferred embodiment, the number of second openings of the suction manifold can be adjusted to the number of intakes. In this case, it is possible that a second opening is connected to each one of the intakes of the plurality of intakes.

Regardless of whether the number of second openings is matched to the number of intakes, it is also possible to connect a second opening to more than one intake. Likewise, an intake can be connected to more than one second opening. In certain cases of application or in certain embodiments of the suction device, both variations can be advantageously in order to distribute the suction force and thus prevent losses of suction power.

In a further preferred embodiment, the first opening of the at least one suction manifold comprises a first inner cross-sectional area and the second openings of the at least one suction manifold each comprise a second inner cross-sectional area, with the first inner cross-sectional area being smaller than the sum of the second inner cross-sectional areas of the second openings. In this regard, it is possible for the second openings to all have the same second inner cross-sectional area or for the second openings to comprise at least partially different second inner cross-sectional areas.

The first inner cross-sectional area and the second inner cross-sectional areas can, for example, be chosen such that no loss of suction power occurs between the first opening of the suction manifold and the second openings of the suction manifold, or that any loss of suction power occurring is only marginal. For example, the inner cross-sectional areas can be approximately circular and defined by the corresponding circular diameter. However, elliptical or differently shaped inner cross-sectional areas are also possible.

In another example, it can also be possible for the sum of the second inner cross-sectional areas to be equal to or greater than the first inner cross-sectional area.

In another preferred embodiment, the at least one distributor comprises at least one decentralized suction line, which connects at least one second opening of the suction manifold with at least one intake of the plurality of intakes. The decentralized suction line is called decentralized because it leads from the second opening of the suction manifold to one of the intakes. It therefore contributes to the branching of the suction force caused by the central suction line. For example, the decentralized suction line has a smaller internal cross-sectional area than the central suction line.

The at least one decentralized suction line can be a pipe or a tube. For example, a pipe may be made of metal, for example steel, stainless steel, or an alloy. Furthermore, a pipe can be designed rigidly or at least partially flexibly. A tube may, for example, consist of a plastic (such as polyvinyl chloride (PVC), polyamide (PA), polyethylene (PE), silicone), a natural rubber (such as natural latex, rubber) or a synthetic rubber (such as synthetic Polymeric Latex, chloroprene rubber (neoprene)). Furthermore, a tube usually has higher flexibility than a pipe, but a tube may also be designed rigidly.

In another preferred embodiment, at least one of the intakes of the plurality of intakes can be designed as one piece with at least one decentralized suction line. For example, the at least one decentralized suction line can pass into the at least one intake. In one example, the at least one intake can be an opening of at least one decentralized suction line.

One advantage of using at least one decentralized suction line is to implement the branch of the central suction line into the intakes using the distributor in a directed manner. For example, the at least one suction line can be defined during the production of the suction device or it can be altered and individually adjusted to a suction process, for example by changing the position of the suction line or by connecting the suction line with another intake.

In another preferred embodiment, the at least one decentralized suction line is integrated into the at least one means for holding or the at least one decentralized suction line forms the at least one means for holding.

If the at least one decentralized suction line is integrated into the at least one means for holding, this results in increased stability by combining the means for holding and the at least one decentralized suction line.

However, in an example in which the at least one decentralized suction line forms the at least one means for holding, it can also be possible that the flexibility of the alignment or the application of the suction device is increased.

If the at least one decentralized suction line is neither partially integrated into the at least one means for holding, nor does it form the at least one means for holding, it is possible that the at least one decentralized suction line is secured to or connected to the at least one means for holding. This can prevent the suction line from damage by the suction line having an anchoring point on the at least one means for holding, which prevents movement of the suction line, which could otherwise be caused by the forces acting when sucking in the granular material.

In another preferred embodiment, the suction manifold is directly connected to the at least one means for holding. This enables a durable and stable construction.

In another preferred embodiment, the suction manifold is indirectly connected to the at least one means for holding via at least one decentralized suction line. This enables, for example, the suppression of vibrations, when the suction line is designed out of a flexible pipe/tube and the material of the flexible pipe/tube can decrease the vibrations, resulting in reduced wear of the suction device.

In a further preferred embodiment, the at least one means for holding is adapted to align at least one intake relatively to the container to be emptied or relative to the at least one second intake. It can also be said that the means for holding is adapted to move at least one intake or to specify its orientation or to position the intake. Aligning the at least one intake relative to the container to be emptied or relative to the at least one second intake may contain a relative movement between the intake and the container to be emptied and/or the at least one second intake. For example, the relative movement can be a translation movement along any spatial direction. Furthermore, it is also possible that the alignment consists of a rotational movement of the at least one intake in relation to the container to be emptied or in relation to the at least one second intake. In this regard, a rotational movement can occur around a rotation axis which is fixed in terms of time and space. However, it is also possible that the rotational axis changes temporally and spatially during the rotational movement. The rotation axis may be a rotation axis which is freely defined in space or may be prescribed by the container to be emptied or at least a part of the suction device itself. For example, the rotational axis can be prescribed by one of the intakes, the at least one means for holding or the at least one decentralized suction line, if present. It is also possible that the alignment comprises a combination of relative movement and rotational movement.

For example, the at least one means for holding can comprise at least one flexible partial member, which enables carrying out a change in the position at said partial member. However, if the means for holding is formed from rigid parts, a similar effect can be enabled, for example, by means of a hinge or a joint, particularly a spherical joint.

In another preferred embodiment, the at least one means for holding, which is adapted to align the at least one intake relative to the container or relative to at least one further intake, can be manually aligned by a user of the suction device to align the at least one intake. In another example, the alignment can be done automatically. In this context, automatic means that the alignment can be performed by a machine. This means that the alignment can be controlled by a machine or a computer. For example, a computer can monitor the container fill level and based on this monitoring, align the intakes. However, it is also possible that the alignment can be controlled by an operator via a means, such as a switch, and carried out by a means of the suction device.

If the at least one means for holding is to be adjusted to at least one intake, it will be possible, for example, to easily adapt the suction device for different operational conditions. For example, at least one of the intakes held by the means for holding can be aligned and can thus track the granular material to be sucked in, for example if the filling level of the container decreases. It can also be possible to adjust the positioning of the intakes to the size and shape of a container.

If the at least one means for holding is adapted to align the at least one intake relative to the container or relative to a second intake, this allows a high number of degrees of freedom when selecting the positioning of the intakes, for example when manufacturing the suction device or in the case of movable means for holding after the manufacturing. For example, before or during use of the suction device.

One advantage which emerges from the movability of the at least one means for holding is increased flexibility to use the suction device with different sized containers and different shapes of container as well as to increased efficiency of the suction process.

In a further preferred embodiment, the at least one means for holding is adapted to be moved at least partially from an operating position to a storage position.

For example, the suction device can be folded together or folded out by a movement of the at least one means for holding, wherein the folded configuration equates to the storage position and the folded out configuration corresponds to the operating position. The storage position is characterized, for example, by the fact that the intakes are closer together by a fold movement of the holding means whereas the intakes have a greater distance to each other in the case of the operating position.

One advantage that results from this is the small size of the suction device for storage purposes.

In a further preferred embodiment, the at least one distributor consists either of glass and/or metal. For example, a partial area consisting of the first end portion and/or the second end portion may consist of glass and/or metal. In addition or alternatively, it is also possible that the at least one decentralized suction line of the suction distributor consists at least partially of glass and/or metal.

The advantage of using glass and/or metal compared to other materials, such as plastics, is the possibility to obtain a very smooth inner surface, for example at the points that can be used for guiding the granular material to be sucked. A smooth surface is characterized, for example, by low surface roughness. For metals, for example, center roughness values of less than 0.2 mm are preferred. For example, for glasses, the center roughness values of less than 2 μm are preferred.

Smooth surfaces may be particularly desired at bends, curves, and branches of the lines. For example, if a granulated material is sucked through the lines, less friction is created on a smooth surface than on a surface with high roughness. Since the changes in direction experienced by the granulate-like material through the suction force are particularly great at bends, curves, and branches due to the granular material rubbing against the material that makes up the line at every change in direction. The resulting friction can be reduced if the inner surface of the line is smoothened. This results in less damage to both the granular material to be sucked in and the line even in case of a smooth surface, which in turn means that the wear is smaller so that the durability of the suction device can be increased.

In a further embodiment, at least one of the intake of the plurality of intakes comprises a cardan suspension. A cardan suspension is a suspension by means of two pivot bearings which are perpendicular to each other. In the case of a cardan suspension, the center of gravity of the suspended object, in this case of at least one intakes, is located below the intersection of the rotary axes, with below relative reference to the force effect against which the cardan suspension is directed, i.e. particularly the gravitational force.

An advantage when using a cardan suspension for the at least one intake is that the intake can always be optimally immersed into the granular material to be sucked in.

The aforementioned problem can also be solved by a method for emptying a container, in particular for emptying a container filled with granulated material, wherein the method comprises connecting a suction device with a central suction line, wherein the suction device comprises a plurality of intakes, at least one distributor and at least one means for holding, which holds at least one first intake of the plurality of intakes at a distance from at least one second intake of the plurality of intakes, wherein the at least one distributor is adapted to connect the plurality of intakes to the central suction line. The method further comprises placing the suction device into a container filled with granular material and sucking the material from the container, by applying negative pressure to the central suction line.

The aforementioned problem can also be solved by a system for emptying a container, in particular for emptying a container filled with granular material, wherein the system comprises a suction device with a central suction line and a suction device comprising a plurality of intakes, at least one distributor and a means for holding, which holds at least one first intake of the plurality of intakes at a distance from at least one second intake of the plurality of intakes and wherein the at least one distributor is adapted to connect the plurality of intakes to the central suction line.

The enclosed drawings illustrate the suction device according to the invention by means of an embodiment. It shows:

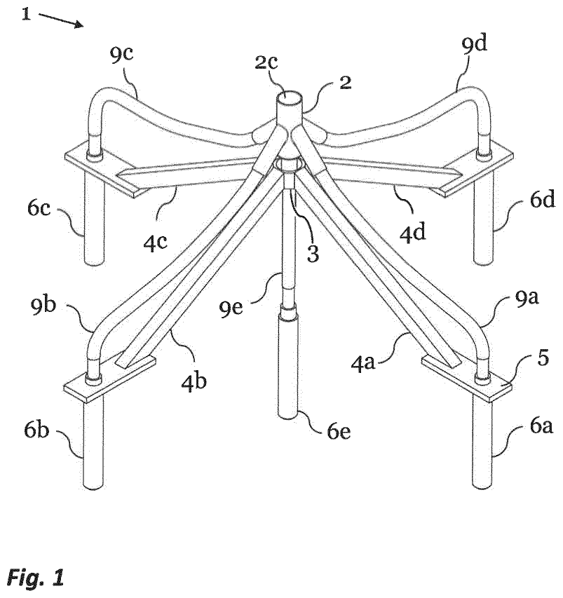

FIG. 1 an isometric representation of an embodiment of the suction device according to the invention,

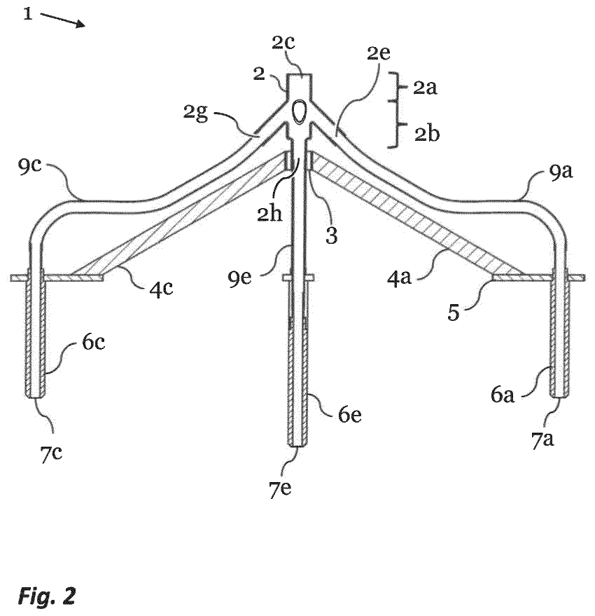

FIG. 2 a sectional drawing of an embodiment of the suction device according to the invention,

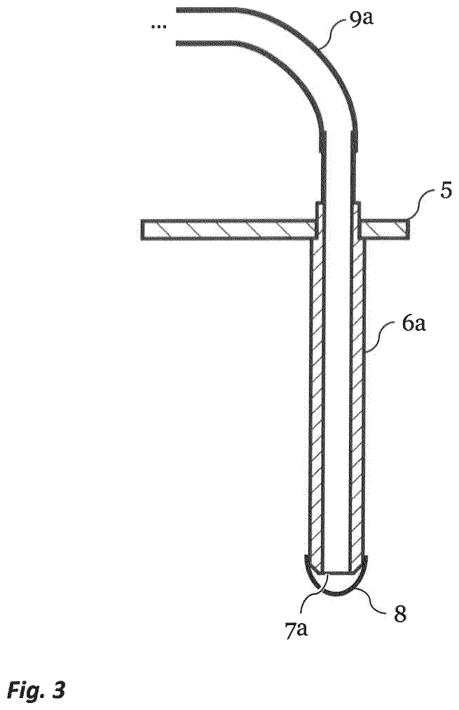

FIG. 3 a detailed drawing of an intake of the suction device according to the invention,

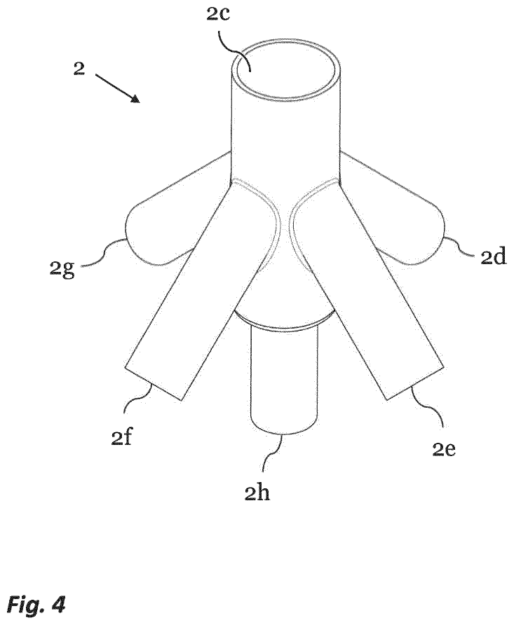

FIG. 4 a detailed drawing of a suction manifold of an embodiment of the suction device according to the invention,

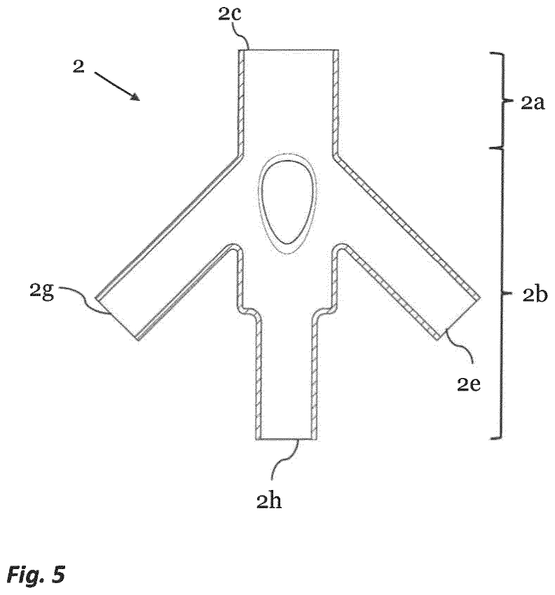

FIG. 5 a sectional drawing of a suction manifold of an embodiment of the suction device according to the invention.

FIG. 1 shows an isometric representation of an embodiment of the suction device 1 according to the invention. The suction device 1 shown here has five intakes 6a-e. Four first intakes 6a-d of this five intakes 6a-e are supported by one means for holding 4a-d, each having the shape of a distributor arm which additionally has a support plate 5. The use of a support plate 5 can increase the stability of the suction device 1 by having an aperture designed to support at least one of the intakes 6a-d. Alternatively or additionally, the support plate 5 can be adapted to increase the weight of the suction device 1 to enable better suction of the granulate-like material, for example by the suction device 1 being drawn into the container by its weight due to the gravitational force, wherein the weight is increased by the support plates 5. As a result, the intakes 6a-d can be better immersed into the granulated material or penetrate it, thus better sucking in the granulated material. The support plates 5 can also be adapted to displace the granulate-like material and thus result in the suction device 1 resting at least partially on the granulate-like material. This could allow only the intakes 6a-e to penetrate at least partially into the granulated material, while the remaining parts of the suction device 1 do not penetrate the granular material. This can, for example, prevent the suction device 1 from being damaged by the granular material. Furthermore, the support plate 5 may comprise a means which enables a movable arrangement of the respective intakes 6a-d at the support plates 5.

Furthermore, the intakes 6a-d are connected to decentralized suction lines 9a-d. The decentralized suction lines 9a-d lead to a suction manifold 2, which connects them with a first opening 2c of the suction manifold 2 with regard to the flow dynamics. The first opening 2c of the suction manifold 2 can be connected to a central suction line that is not shown here. In the embodiment shown here, the decentralized suction lines 9a-e are represented in the form of tubes. However, it is also possible that the suction lines 9a-e are designed in the form of pipes or are also integrated in one of the means for holding 4a-d or form the means for holding 4a-d itself.

The second intake 6e is connected to a suction line 9e, which also serves as a means for holding for this intake 6e.

In the case of the embodiment in FIG. 1, each means for holding 4a-d holds a respective first intake 6a-d at a certain distance to at least one other intake 6a-d of the plurality of intakes 6a-e, for example the intake 6e, which can be referred to as a second intake. The first intakes 6a-d differ from the second intake 6e in that each of them is arranged at a means for holding 4a-d, whereas the intake 6e is only arranged at a suction line 9e. The means for holding 4a-d are connected to each other via a holder 3.

The means for holding 4a-d hold the four first intakes 6a-d in a rectangular shape, with one first intake 6a-d being located in one of the four corners of the rectangle. The second intake 6e is located inside the rectangle, which is formed by the first four intakes 6a-d.

In the embodiment of FIG. 1, the suction manifold 2, the decentralized suction lines 9a-e together with the holder 3 form a distributor.

If the suction device 1 is connected to a central suction line not shown here with the first opening 2c of the suction manifold 2, a vacuum generated at the central suction line is transmitted to the first and second intakes 6a-e. This creates a suction on the first and second intakes 6a-e. This suction generates a suction force by means of which granulate-like material can be sucked through the intakes 6a-e and routed through the first opening 2c of the suction manifold 2 to the central suction line. In this way granulated material can be extracted from a container not shown here and the container can be emptied.

If granulated material is extracted by means of the intakes 6a-e arranged in a rectangle, the granulate-like material is extracted at the positions where the intakes 6a-e are located. It may be possible that granulated material remains in other places where there is no intake. As a result, hills of granulate-like material may from where the granulate-like material can slip to the positions of the intakes 6a-e due to the gravitational force applied to the individual particles of the granulate-like material. These slipping particles can then be extracted by the intakes 6a-e.

For example, the smaller the hills of granulate-like material, this effect of slipping can become smaller. If the hills have become so small that no granulate-like material can slip, it can be advantageously to reposition the suction device 1 and turn it relatively to the container so that the intakes are placed in the places where remaining granulate-like material is located. In many cases, it is sufficient to turn the suction device 1 once. For example, if the suction device 1 has five intakes 6a-e and four first intakes 6a-d are positioned in a square while the remaining intake 6e is located in the surface of the square. In this example, in the spaces between the four corners of the square, a total of four hills can form made out of granulated material. Therefore, it is sufficient to turn the suction device one time by 45° so that the first four intakes reach the positions of the four hills.

FIG. 2 shows a sectional drawing of an embodiment example of the suction device 1 according to the invention, for example a sectional drawing of the embodiment as shown in FIG. 1. The sectional drawing of FIG. 2 shows the suction device 1. The suction device 1 has the intakes 6a-e connected to the suction lines 9a-e. The intakes 6a-d are also connected to the means for holding 4a-d, each having a support plate 5. In the case of the intake 6e, the suction line 9e serves as a means for holding. The intakes 6a-e have suction openings 7a-e.

Furthermore, the suction device 1 of the embodiment according to FIG. 2 comprises a suction manifold 2, which, in turn, comprises a first end portion 2a and a second end portion 2b. The first end portion 2a of the suction manifold 2 has a first opening 2c, which is adapted to be connected to a central suction line that is not shown here. The second end portion 2b has a plurality of second openings 2d-h. Each of the second openings 2d-h is connected to one of the suction lines 9a-e.

In the sectional drawing of FIG. 2, it can be seen that the suction openings 7a, 7c, 7e of the intakes 6a, 6c, 6e of the shown embodiment form a contiguous flow-dynamic connection via the suction lines 9a, 9c, 9e and the suction manifold 2, which ends in the first opening 2c of the suction manifold 2, which is connected to the central suction line that is not shown. This flow dynamic connection is suitable for the effective extraction of granulated material from a container.

FIG. 3 shows a detailed drawing of an intake of an embodiment of the suction device according to the invention, for example a detailed drawing of a suction device of the embodiment shown in FIG. 1.

The intake 6a shown in FIG. 3 comprises a spacer 8. The spacer 8, which can be designed in an arched manner, rectangular, or trapezoid manner, for example, is depicted in an arched manner in FIG. 3 and extends at least partially over the suction opening 7a of the intake 6a.

The spacer 8 ensures that the corresponding suction opening 7a of the intake 6a does not come into contact with the container. Thereby, it is avoided that the intake 6a attaches to the container, particularly if the container to be emptied has a flexible inner container. Moreover, such a spacer 8 also prevents larger particles of the granular material to be sucked in, which may cause jamming of the suction openings 7a.

FIG. 4 shows a detailed drawing of a suction manifold of an embodiment of the suction device according to the invention, for example a detailed drawing of a suction manifold of the embodiment shown in FIG. 1.

The suction manifold 2 of the embodiment from FIG. 2 comprises a first opening 2c, which is adapted to be connected to a central suction line. Furthermore, the suction manifold 2 comprises a branch of several lines ending in a plurality of second openings 2d-h. In the case shown, five branches are shown, but any number of branches is possible.

In the embodiment shown, the four lines leading to the openings 2d-g have an angle relative to the line that ends in the first opening 2c, while the line leading to the opening 2h does not have an angle with regards to the first opening 2c. The second opening 2h, in which this latter line ends, is thus parallel to the first opening 2c.

The suction manifold 2 allows the suction from the first opening 2c to be split between the plurality of second openings 2d-h. The winding of the lines ensures that the line is in a spatial relationship with the first opening 2c, which is advantageous to the flow dynamics, and that suction power is not lost or that the suction power losses are marginal. In a preferred embodiment, the lines are at an angle of 45° to the normal of the opening 2c, as it is shown in the embodiment of FIG. 4.

FIG. 5 shows a sectional drawing of a suction manifold of an embodiment example of the suction device according to the invention, for example a sectional drawing of the suction manifold shown in FIG. 4.

The suction manifold 2 from FIG. 5 comprises a first end portion 2a and a second end portion 2b, with the first end portion 2a comprising a first opening 2c, which is adapted to be connected to a central suction line that is not shown, and the second end portion 2b comprises a plurality of second openings 2e, 2g, 2h.

In the embodiment shown , the first opening 2c comprises a first diameter and the second openings 2e, 2g, 2h comprise a second diameter, wherein in the shown embodiment each second openings 2e, 2g, 2h have the same second diameter and the second diameter is smaller than the first diameter.

Moreover, the first opening 2c of the at least one suction manifold 2 comprises a first cross-sectional area and the second openings 2e, 2g, 2h of the at least one suction manifold 2 each comprises a second cross-sectional area, with the first cross-sectional area being smaller than the sum of the second cross-sectional areas of the second openings. In the example shown in FIG. 5, the second openings 2e, 2g, 2h all comprise the same second cross-sectional area.

The above description includes embodiments examples of one or more embodiments of the invention. Of course, it is not possible to describe any conceivable combination of the components and methods according to the invention in the above-mentioned embodiments. Rather, the person skilled in the art will recognize that there are numerous other combinations. Accordingly, the described embodiments are to comprise all of these further combinations, modifications, variations and embodiments that fall under the scope of application of the attached claims.

1. A suction device for emptying a container, in particular for emptying a container filled with granulated material, the suction device comprising:
a plurality of intakes;
at least one distributor, wherein the at least one distributor is adapted to connect the plurality of intakes to a central suction line; and
at least one means for holding at least one first intake of the plurality of intakes at a distance from at least one second intake of the plurality of intakes.

2. The suction device according to claim 1, wherein the at least one distributor comprises at least one suction manifold comprising a first end portion and a second end portion, wherein
the first end portion comprises a first opening adapted to be connected to the central suction line, and
the second end portion comprises a plurality of second openings, wherein each of the second openings is adapted to be connected to at least one intake.

3. The suction device according to claim 2, wherein the first opening of the at least one suction manifold has a first inner cross-sectional area and the second openings of the at least one suction manifold each comprise a second inner cross-sectional area and wherein the first inner cross-sectional area is smaller than the sum of the second inner cross-sectional areas of the second openings.

4. The suction device according to claim 2, wherein the at least one distributor further comprising at least one decentralized suction line, which connects at least one second opening of the at least one suction manifold with at least one intake of the plurality of intakes.

5. The suction device according to claim 4, wherein the at least one decentralized suction line is at least partially integrated into the at least one means for holding or the at least one decentralized suction line forms the at least one means for holding.

6. The suction device according to claim 3, wherein the at least one suction manifold is directly connected to the at least one means for holding.

7. The suction device according to claim 4, wherein the at least one suction manifold is indirectly connected to the at least one means for holding via the at least one decentralized suction line.

8. The suction device according to claim 1, wherein the at least one means for holding is adapted to align the at least one intake relative to the container to be emptied or relative to the at least one second intake.

9. The suction device according to claim 1, wherein the at least one means for holding is adapted to be moved from an operating position into a storage position.

10. The suction device according to claim 1, wherein the at least one distributor consists at least partially of glass and/or a metal.
